(19) United States
(12) Patent Application Publication
(10) Pub. No.: US 2013/0229961 A1
(43) Pub. Date: Sep. 5, 2013

(54) METHODS AND DEVICES FOR POSITIONING AN ACCESS TERMINAL UTILIZING A HIGHLY DETECTABLE PILOT

(71) Applicants: Jun Ma, San Diego, CA (US); Wanlun Zhao, San Diego, CA (US); Rashid Ahmed Akbar Attar, San Diego, CA (US)

(72) Inventors: Jun Ma, San Diego, CA (US); Wanlun Zhao, San Diego, CA (US); Rashid Ahmed Akbar Attar, San Diego, CA (US)

(73) Assignee: Qualcomm Incorporated, San Diego, CA (US)

(21) Appl. No.: 13/599,017

(22) Filed: Aug. 30, 2012

Related U.S. Application Data
(60) Provisional application No. 61/554,882, filed on Nov. 2, 2011.
(60) Provisional application No. 61/594,889, filed on Feb. 3, 2012.
(60) Provisional application No. 61/596,213, filed on Feb. 7, 2012.

(51) Int. Cl. H04W 52/02

(52) U.S. Cl. CPC H04W 52/0216
USPC 370/311

(57) ABSTRACT

Apparatus and methods are disclosed for positioning an access terminal in a CDMA wireless communication network utilizing a highly detectable pilot (HDP) scheme. Here, transmissions by base stations are divided in the time dimension into a plurality of time slots, or pilot control groups (PCGs). A subset of these time slots, according to a duty cycle, are exclusively allocated to the transmission of the HDP signals, while conventional data, control, and pilot transmissions are forgone during these HDP time slots. Among the HDP time slots, in accordance with a re-use pattern, groups of the cells take turns transmitting the HDPs at full base station power. In this way, access terminals are better capable of receiving a greater set of pilot signals for utilization in trilateration of the access terminals. Other aspects, embodiments, and features are also claimed and described.

### CROSS-REFERENCE TO RELATED APPLICATIONS & PRIORITY CLAIMS

This application claims priority to and the benefit of: (a) provisional patent application No. 61/554,882, filed in the United States Patent and Trademark Office on Nov. 2, 2011, titled, Devices, Methods, and Systems for Highly Detectable Pilot Channel Structure for CDMA2000 1×; (b) provisional patent application No. 61/594,889, filed in the United States Patent and Trademark Office on Feb. 3, 2012, titled, Apparatus and Method for Communicating a Highly Detectable Pilot in Wireless Communications; and (c) provisional patent application No. 61/596,213, filed in the United States Patent and Trademark Office on Feb. 7, 2012, titled, Special Mode for HDP Nodes that only do Blanking but do not Actually Transmit HDP. All of said applications are incorporated herein by reference as if fully set forth below and for all purposes.

### TECHNICAL FIELD

The following relates generally to wireless communication, and more specifically to methods and devices for positioning an access terminal utilizing trilateration in a wireless communication network.

### BACKGROUND

Wireless communications systems are widely deployed to provide various types of communication content such as voice, video, packet data, messaging, broadcast, and so on. These systems may be accessed by various types of access terminals adapted to facilitate wireless communications, where multiple access terminals share the available system resources (e.g., time, frequency, and power). Examples of such wireless communications systems include code-division multiple access (CDMA) systems, time-division multiple access (TDMA) systems, frequency-division multiple access (FDMA) systems and orthogonal frequency-division multiple access (OFDMA) systems.

With modern mobile wireless equipment, the availability of positioning technology has brought about a rapid increase in deployment of various location-based services. These services are desirable both for users, having an improved user experience, as well as for service providers, who can target advertisements and other services narrowly based on users' location. Positioning technologies include satellite navigation systems such as the Global Positioning System (GPS), as well as radiolocation utilizing trilateration between base stations in the wireless network. Combinations of these technologies may also be used, such as assisted GPS, which supports GPS data with additional information from a cellular network.

GPS utilizes a receiver at the access terminal to receive signals transmitted from satellites in orbit. While GPS is effective and accurate, the power required to utilize its receive amplifier to enable reception of weak and distant signals is relatively great, and can result in substantial reductions in battery life.

Advanced Forward Link Trilateration (AFLT) is one positioning technology that many modem wireless access terminals utilize. With AFLT, to determine its location, an access terminal measures pilot signals from nearby base stations, so that the location can be triangulated based on the timing of multiple signals transmitted from known locations. While at least three pilot signals are generally required to determine a location of the access terminal, to improve the precision and effectiveness of AFLT, the larger the number of pilot signals from different base stations, the better.

While AFLT can effectively position the access terminal with less battery consumption than GPS, in certain scenarios, particularly when few pilot signals are available, its performance can be poor. Thus, improvements in positioning technology that maintain the energy savings of AFLT would be desirable. Embodiments of the present invention are provisioned to address these issues as well as others.

### BRIEF SUMMARY OF SOME EMBODIMENTS

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a method of positioning an access terminal in a wireless communication network. Here, the method includes transmitting a pilot if a current time slot is a designated highly detectable pilot (HDP) time slot, and blanking pilot, traffic, and signaling transmissions if the current time slot is an HDP time slot that is not a designated HDP time slot.

Another aspect of the disclosure provides a method of positioning an access terminal in a wireless communication network. Here, the method includes determining that a current time slot is a highly detectable pilot (HDP) time slot, receiving an HDP transmission during the current time slot, storing information corresponding to the received HDP in memory, transmitting a reporting message comprising the information corresponding to the received HDP, and receiving position information responsive to the transmitting of the reporting message.

Another aspect of the disclosure provides a base station configured for positioning an access terminal in a wireless communication network. Here, the base station includes means for transmitting a pilot if a current time slot is a designated highly detectable pilot (HDP) time slot, and means for blanking pilot, traffic, and signaling transmissions if the current time slot is an HDP time slot that is not a designated HDP time slot.

Another aspect of the disclosure provides an access terminal configured for positioning in a wireless communication network. Here, the access terminal includes means for determining that a current time slot is a highly detectable pilot (HDP) time slot, means for receiving an HDP transmission during the current time slot, means for storing information corresponding to the received HDP in memory, means for transmitting a reporting message comprising the information corresponding to the received HDP, and means for receiving position information responsive to the transmitting of the reporting message.

Another aspect of the disclosure provides a base station configured for positioning an access terminal in a wireless communication network. Here, the base station includes a processing circuit, a communications interface coupled to the processing circuit, and a memory coupled to the processing circuit, wherein the processing circuit is configured to transmit a pilot if a current time slot is a designated highly detectable pilot (HDP) time slot, and to blank pilot, traffic, and signaling transmissions if the current time slot is an HDP time slot that is not a designated HDP time slot.

Another aspect of the disclosure provides an access terminal configured for positioning in a wireless communication network. Here, the access terminal includes a processing circuit, a communications interface coupled to the processing circuit, and a memory coupled to the processing circuit, wherein the processing circuit is configured to determine that a current time slot is a highly detectable pilot (HDP) time slot, to receive an HDP transmission during the current time slot, to store information corresponding to the received HDP in memory, to transmit a reporting message comprising the information corresponding to the received HDP, and to receive position information responsive to the transmitting of the reporting message.

Another aspect of the disclosure provides a computer program product operable at a base station, including a computer-readable storage medium having instructions for causing a computer to transmit a pilot if a current time slot is a designated highly detectable pilot (HDP) time slot, and to blank pilot, traffic, and signaling transmissions if the current time slot is an HDP time slot that is not a designated HDP time slot.

Another aspect of the disclosure provides a computer program product operable at an access terminal, including a computer-readable storage medium having instructions for causing a computer to determine that a current time slot is a highly detectable pilot (HDP) time slot, to receive an HDP transmission during the current time slot, to store information corresponding to the received HDP in memory, to transmit a reporting message comprising the information corresponding to the received HDP, and to receive position information responsive to the transmitting of the reporting message.

These and other aspects of the invention will become more fully understood upon a review of the detailed description, which follows.

### BRIEF DESCRIPTION OF THE DRAWINGS

FIG. 1 is a block diagram illustrating an example of a processing circuit that may be utilized in one or more aspects of the disclosure.

FIG. 2 is a schematic diagram illustrating an example of an access network in which one or more aspects of the disclosure may find application.

FIG. 3 is a block diagram illustrating an example of a protocol stack architecture which may be implemented for communication between an access terminal and a wireless communication network.

FIG. 4 is a schematic diagram illustrating an access network configured for highly detectable pilot transmissions in accordance with one aspect of the disclosure.

FIG. 5 is a schematic diagram illustrating highly detectable pilot transmissions in accordance with one aspect of the disclosure.

FIG. 6 is simplified block diagram illustrating some aspects of a base station according to one example.

FIG. 7 is a flow chart illustrating a process of transmitting highly detectable pilots operable at a base station according to some aspects of the disclosure.

FIG. 8 is a simplified block diagram illustrating some aspects of an access terminal according to one example.

FIG. 9 is a flow chart illustrating a process of receiving highly detectable pilots operable at an access terminal according to some aspects of the disclosure.

### DETAILED DESCRIPTION OF SOME EMBODIMENTS

In the following description, specific details are given to provide a thorough understanding of the described implementations. However, it will be understood by one of ordinary skill in the art that at least some of the aspects described herein may be practiced without these specific details. For example, circuits may be shown in block diagrams in order not to obscure the implementations in unnecessary detail. In other instances, well-known circuits, structures and techniques may be shown in detail in order not to obscure the implementations.

In the following description, certain terminology is used to describe certain features of one or more implementations. The terms “access terminal” and “programming” as used herein are meant to be interpreted broadly. For example, an “access terminal” refers generally to one or more devices that communicate with one or more other devices through wireless signals. Such access terminals may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. Access terminals may include mobile terminals and/or at least substantially fixed terminals. Examples of access terminals include mobile phones, pagers, wireless modems, personal digital assistants, personal information managers (PIMs), personal media players, palmtop computers, laptop computers, tablet computers, televisions, appliances, e-readers, digital video recorders (DVRs), machine-to-machine (M2M) devices, and/or other communication/computing devices which communicate, at least partially, through a wireless or cellular network.

Furthermore, the term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

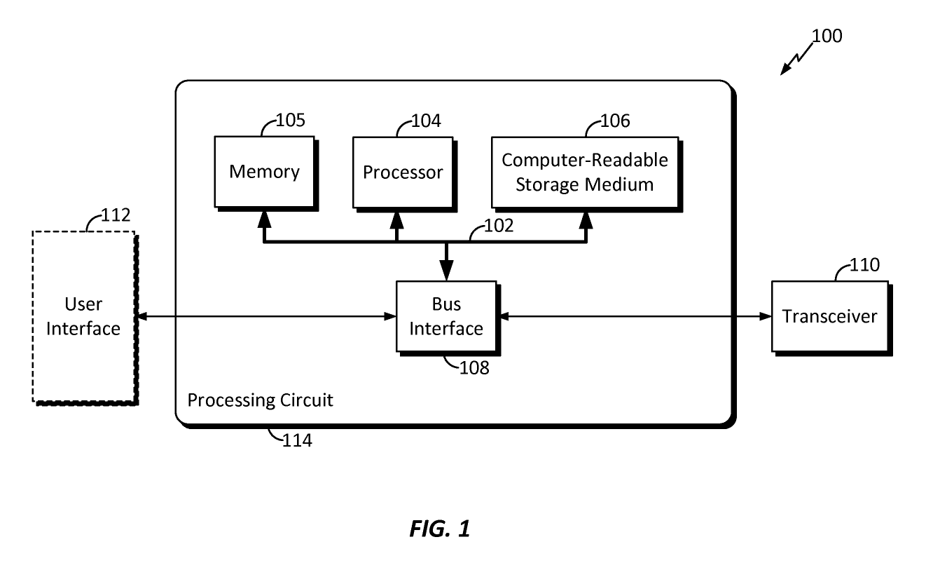

FIG. 1 is a conceptual diagram illustrating an example of a hardware implementation for an apparatus 100 employing a processing circuit 114. In accordance with various aspects of the disclosure, an element, or any portion of an element, or any combination of elements may be implemented with a processing circuit 114 that includes one or more processors 104. Examples of processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing circuit 114 may be implemented with a bus architecture, represented generally by the bus 102. The bus 102 may include any number of interconnecting buses and bridges depending on the specific application of the processing circuit 114 and the overall design constraints. The bus 102 links together various circuits including one or more processors (represented generally by the processor 104), a memory 105, and computer-readable media (represented generally by the computer-readable storage medium 106). The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable storage medium 106. The software, when executed by the processor 104, causes the processing circuit 114 to perform the various functions described infra for any particular apparatus. The computer-readable storage medium 106 may also be used for storing data that is manipulated by the processor 104 when executing software.

One or more processors 104 in the processing circuit may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium 106. The computer-readable storage medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable storage medium 106 may reside in the processing circuit 114, external to the processing circuit 114, or distributed across multiple entities including the processing circuit 114. The computer-readable storage medium 106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The various concepts presented throughout this disclosure may be implemented across a broad variety of telecommunication systems, network architectures, and communication standards. Although the discussions herein may present examples of CDMA and 3rd Generation Partnership Project 2 (3GPP2) 1× protocols and systems, those of ordinary skill in the art will recognize that one or more aspects of the present disclosure may be employed and included in one or more other wireless communication protocols and systems.

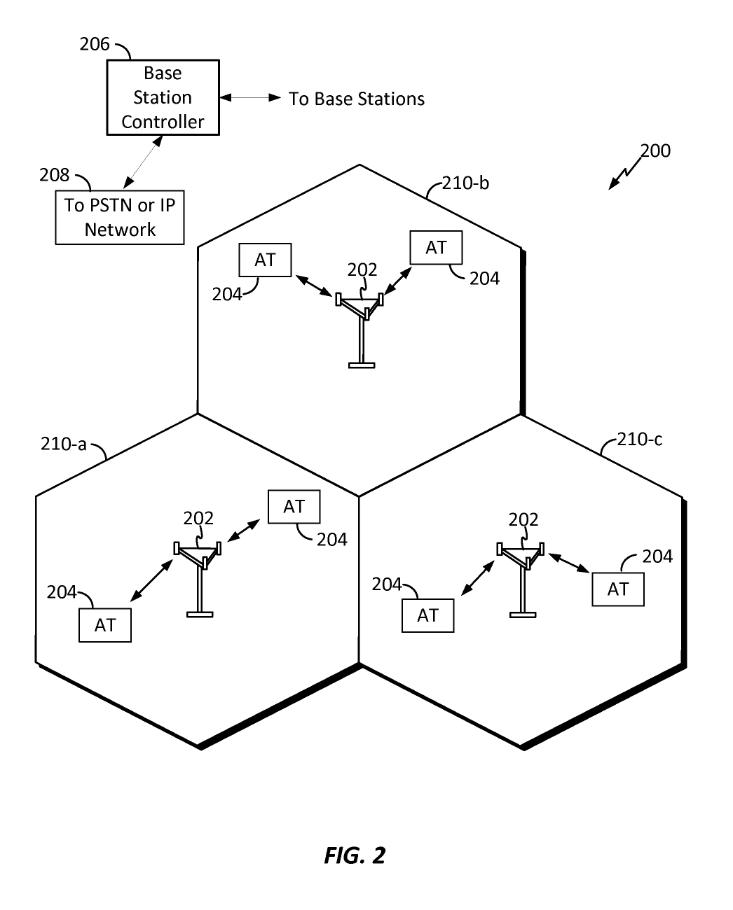

FIG. 2 is a conceptual diagram illustrating an example of an access network in which one or more aspects of the present disclosure may find application. The wireless communication system 200 generally includes one or more base stations 202, one or more access terminals 204, one or more base station controllers (BSC) 206, and a core network 208 providing access to a public switched telephone network (PSTN) (e.g., via a mobile switching center/visitor location register (MSC/VLR)) and/or to an IP network (e.g., via a packet data switching node (PDSN)). The system 200 may support operation on multiple carriers (waveform signals of different frequencies). Multi-carrier transmitters can transmit modulated signals simultaneously on the multiple carriers. Each modulated signal may be a CDMA signal, a TDMA signal, an OFDMA signal, a Single Carrier Frequency Division Multiple Access (SC-FDMA) signal, etc. Each modulated signal may be sent on a different carrier and may carry control information (e.g., pilot signals), overhead information, data, etc.

The base stations 202 may wirelessly communicate with the access terminals 204 via a base station antenna. The base stations 202 may each include a device that facilitates wireless connectivity (for one or more access terminals 204) to the wireless communications system 200. For example, the base stations 202 may include access points, base transceiver stations (BTS), radio base stations, radio transceivers, transceiver functions, basic service sets (BSS), extended service sets (ESS), Node Bs, femto cells, pico cells, and/or some other suitable device.

The base stations 202 are configured to communicate with the access terminals 204 under the control of the base station controller 206 via multiple carriers. Each of the base stations 202 can provide communication coverage for a respective geographic area. The coverage area 210 for each base station 202 here is identified as cells 210-a, 210-b, or 210-c. The coverage area 210 for a base station 202 may be divided into sectors (not shown, but making up only a portion of the coverage area). In a coverage area 210 that is divided into sectors, the multiple sectors within a coverage area 210 can be formed by groups of antennas with each antenna responsible for communication with one or more access terminals 204 in a portion of the cell.

The access terminals 204 may be dispersed throughout the coverage areas 210, and may wirelessly communicate with one or more sectors associated with each respective base station 202. The access terminal 204 may be adapted to employ a protocol stack architecture for communicating data between the access terminal 204 and one or more network nodes of the wireless communication system 200 (e.g., the base station 202). A protocol stack generally includes a conceptual model of the layered architecture for communication protocols in which layers are represented in order of their numeric designation, where transferred data is processed sequentially by each layer, in the order of their representation. Graphically, the “stack” is typically shown vertically, with the layer having the lowest numeric designation at the base.

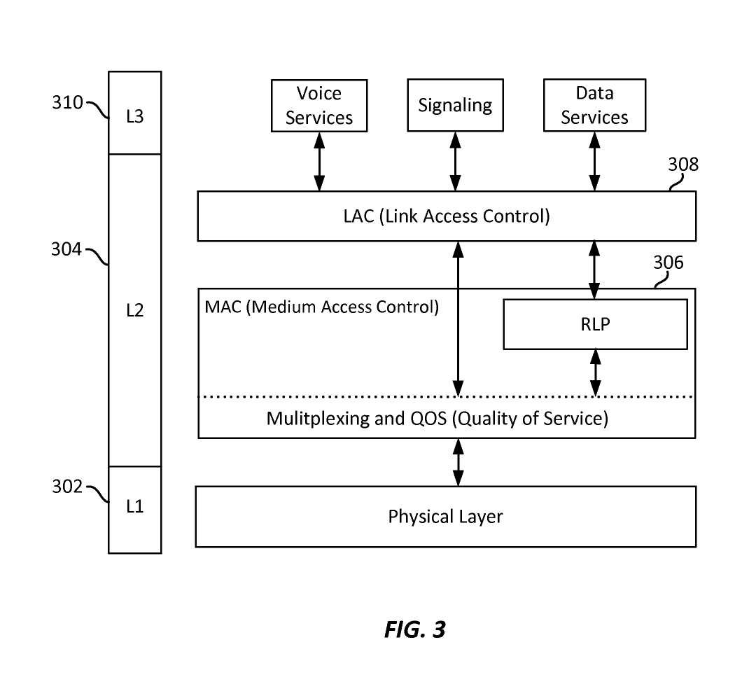

FIG. 3 is a block diagram illustrating an example of a protocol stack architecture which may be implemented by an access terminal 204 operating in the cdma2000 1× access network described above. Referring to FIGS. 2 and 3, the protocol stack architecture for the access terminal 204 is shown with three layers: Layer 1 (L1), Layer 2 (L2), and Layer 3 (L3).

Layer 1 302 is the lowest layer and implements various physical layer signal processing functions. Layer 1 302 is also referred to herein as the physical layer 302. This physical 302 provides for the transmission and reception of radio signals between the access terminal 204 and a base station 202.

The data link layer, called layer 2 (or “the L2 layer”) 304 is above the physical layer 302 and is responsible for delivery of signaling messages generated by Layer 3. The L2 layer 304 makes use of the services provided by the physical layer 302. The L2 layer 304 may include two sublayers: the Medium Access Control (MAC) sublayer 306, and the Link Access Control (LAC) sublayer 308.

The MAC sublayer 306 is the lower sublayer of the L2 layer 304. The MAC sublayer 306 implements the medium access protocol and is responsible for transport of higher layers' protocol data units using the services provided by the physical layer 302. The MAC sublayer 306 may manage the access of data from the higher layers to the shared air interface.

The LAC sublayer 308 is the upper sublayer of the L2 layer 304. The LAC sublayer 308 implements a data link protocol that provides for the correct transport and delivery of signaling messages generated at the layer 3. The LAC sublayer makes use of the services provided by the lower layers (e.g., layer 1 and the MAC sublayer).

Layer 3 310, which may also be referred to as the upper layer or the L3 layer, originates and terminates signaling messages according to the semantics and timing of the communication protocol between a base station 202 and the access terminal 204. The L3 layer 310 makes use of the services provided by the L2 layer. Information (both data and voice) message are also passed through the L3 layer 310.

By utilizing the above-described communication protocol architecture in the above-described access network 200, some aspects of the present disclosure can provide improved position accuracy relative to conventional trilateration positioning technology. That is, one or more aspects of the present disclosure provide for a highly detectable pilot (HDP) that can increase the number of pilots detectable by an access terminal 204, increasing the positioning accuracy. For example, in some cases where the access terminal 204 is a low-cost machine-to-machine (m2m) device, the device may benefit from the improved positioning accuracy enabled by utilizing the HDP described in the present disclosure. Moreover, in some cases where the access terminal 204 includes GPS technology, the positioning of the device can be improved when GPS is degraded or inaccessible by utilizing trilateration with the HDP described herein.

That is, some access terminals 204 may include global positioning satellite a (GPS) receiver enabling accurate and reliable positioning information when the signals are available. However, an issue with GPS is that the access terminal may lack the ability to receive satellite measurements in indoor and dense urban cases. In these cases, to maintain positioning capabilities for the access terminal, base station measurements can be an effective supplement for positioning the access terminal.

Advanced Forward Link Trilateration (AFLT) is one positioning technology that many modem wireless access terminals utilize. With AFLT, to determine its location, an access terminal 204 measures pilot signals from a plurality of nearby base stations 202, so that the location of the access terminal 204 can be triangulated based on the timing of multiple signals transmitted from known locations. While at least three pilot signals are generally required to determine a location of the access terminal, to improve the precision and effectiveness of AFLT, the larger the number of pilot signals from different base stations, the better.

According to conventional AFLT, each base station transmits a continuous pilot signal including certain characteristics that enable access terminal, upon receiving a plurality of these pilot signals, to determine its position. For example, the access terminal may measure characteristics of the received pilots such as timing and signal strength, to determine distance between the access terminal and the base station, and may then report these measurements to the network. The network may then calculate the position of the access terminal and either utilize this position information to provide location-based services to the access terminal, or transmit the position information to the access terminal itself for mapping or any other application that might benefit from such information.

Others have attempted to improve the performance of radiolocation technology utilizing trilateration (such as AFLT) by altering the structure of the pilot transmitted by the base stations, to make the pilots more easily detectable by the access terminal For example, U.S. Patent Application Publication No. 2010/0074344, titled, “Highly Detectable Pilot Structure,” disclosed such a pilot for use in a wireless network utilizing OFDM on its forward link. Specifically, particular resource elements separated from other resource elements utilized for data transmission in one or both of time and frequency, can be dedicated to a pilot. As described therein, each base station is assigned a particular resource element for transmission of a highly detectable pilot signal. This way, collision and interference of pilots from different pilots within a given area can be reduced, such that the access terminal is more likely to receive the pilots from a sufficiently large number of base stations.

However, in OFDM technology, the capability to separate pilots in both frequency (i.e., by subcarrier) and time, and the way both pilot and data share resources in such an OFDM channel, makes HDP schemes previously considered unavailable for CDMA technology. Moreover, in a single-carrier network such as cdma2000 1×, by cause of the so-called near-far effect, the pilot transmitted by nearby base stations, particularly from nearby high-power base stations, can drown out the pilots transmitted by more distant or lower-power base stations, reducing the number of signals that can be received at the access terminal for positioning. This problem can be more pronounced in heterogeneous networks where some base stations transmit at substantially higher power than others. Thus, any scheme that can enable an increase in the number of pilot signals that can be received by a mobile access terminal could improve the accuracy and effectiveness of AFLT.

Therefore, various aspects of the present disclosure provide a highly detectable pilot (HDP) that is structured to enable a relatively large number of pilot signals to be received at the access terminal, configured for use by a continuous pilot technology such as cdma2000 1×.

Various aspects of the present disclosure may be incorporated into various components of a communication system. For example, some aspects may be implemented in network-based components (e.g., network control or communication devices), user equipment components (e.g., access terminals or mobile devices), or a combination thereof.

In a conventional cdma2000 1× access network, each cell continuously transmits a pilot signal called a forward pilot channel (F-PICH). The F-PICH includes a constant, unmodulated value, scrambled by a pseudo-random number (PN) sequence. The PN sequence can be utilized to identify the base station transmitting the F-PICH. Further, the F-PICH enables an access terminal to acquire the timing of the forward link CDMA channel, provides a phase reference for coherent demodulation, and assists in handoff between cells.

CDMA channel frames may be structured in 5, 10, or 20 ms formats. The specific frame configuration is generally negotiated between the base station and the access terminal utilizing layer 3 signaling. Some channels, including the F-PICH, are structured such that consecutive frames are grouped together into slots. Specifically, for the F-PICH, transmissions are divided into 80 ms slots. In some conventional cdma2000 1× networks that utilize a 20 ms frame, each 20 ms frame is divided into 16 power control groups (PCG) of 1.25 ms each. That is, a PCG can be considered a 1.25 ms time slot.

In the disclosure that follows, for clarity and ease of explanation, PCGs are universally utilized to describe time slots for characterizing the highly detectable pilot (HDP). However, those of ordinary skill in the art will comprehend that aspects of the disclosure may be applied to other technologies in addition to cdma2000 1×, wherein time division of pilot transmissions may be utilized to implement the HDP as disclosed herein. That is, when referring to PCGs and HDP PCGs in the present disclosure, those of ordinary skill in the art will comprehend that any suitable terminology may be utilized to describe the division of the pilot into a plurality of time slots.

As described above, some aspects of the present disclosure provide a highly detectable pilot (HDP). The HDP can be structured to improve the probability that an access terminal 204 might receive a relatively large number of pilot signals, so as to improve the performance of a trilateration-based radiolocation technology.

In an exemplary HDP scheme according to some aspects of the disclosure, a subset of the PCGs may be allocated for transmission of the highly detectable pilot (HDP) only. That is, an HDP PCG may be defined, during which most base stations 202 in the access network 200 shut down transmissions to reduce or eliminate interference, while a subset of the base stations 202 transmit the pilot signal during the HDP PCG. The transmission of the HDP amongst the base stations 202 can be coordinated such that different base stations use different HDP PCGs, in a time-division multiplexing fashion.

Some aspects of the disclosure may utilize a relatively low duty cycle, e.g., where 1% of PCGs are utilized for transmission of the HDP. This low duty cycle can accordingly reduce the impact on network capacity. That is, because relatively few PCGs are dedicated to the transmission of the HDPs, a greater number of PCGs are available for other purposes such as signaling and data. Furthermore, by dedicating a particular PCG for the transmission of the HDP while blanking transmissions by other base stations, transmission of the HDP at full sector power may be enabled, making the pilot more easily detectable by an access terminal 204. This is distinguished from the conventional trilateration scheme that relies only upon the transmission of a continuous pilot, and can suffer from the near-far effect or other undesired interference and resulting in fewer pilots available for positioning.

In a further aspect of the disclosure, an HDP scheme may utilize a reuse factor such that only a subset, e.g., 1 in 9 base stations, utilize a particular HDP PCG for transmission of the highly detectable pilot.

In this way, the higher transmit power (i.e., the F-PICH being transmitted at full sector power) and the reduced interference caused by the reuse factor, makes the pilot channel more detectable, and thus, increases the number of pilot signals that the access terminal can utilize to determine its position.

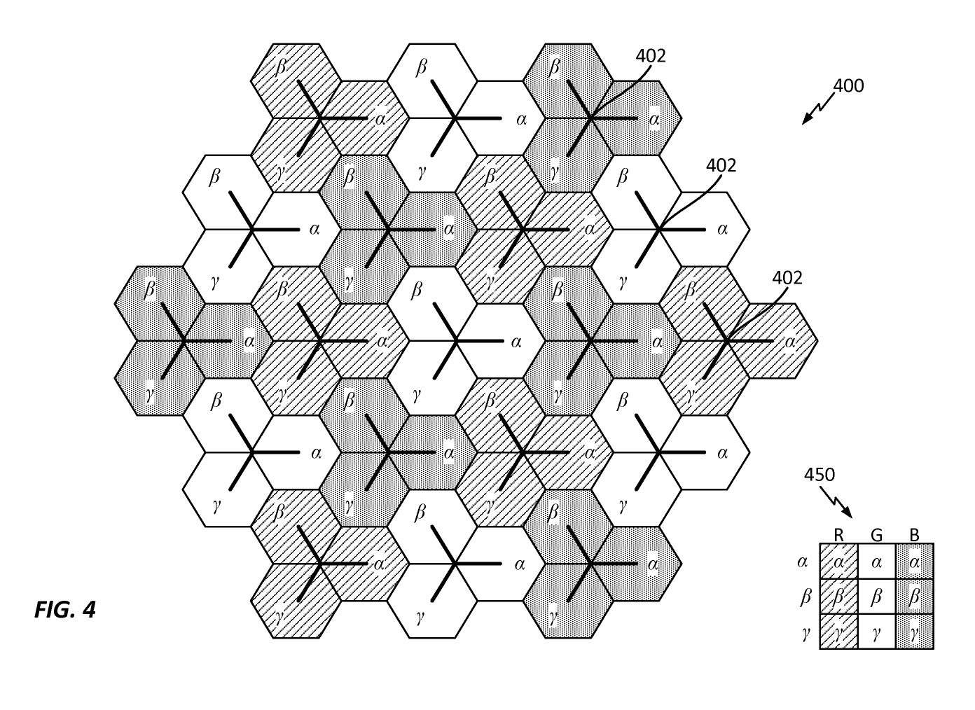

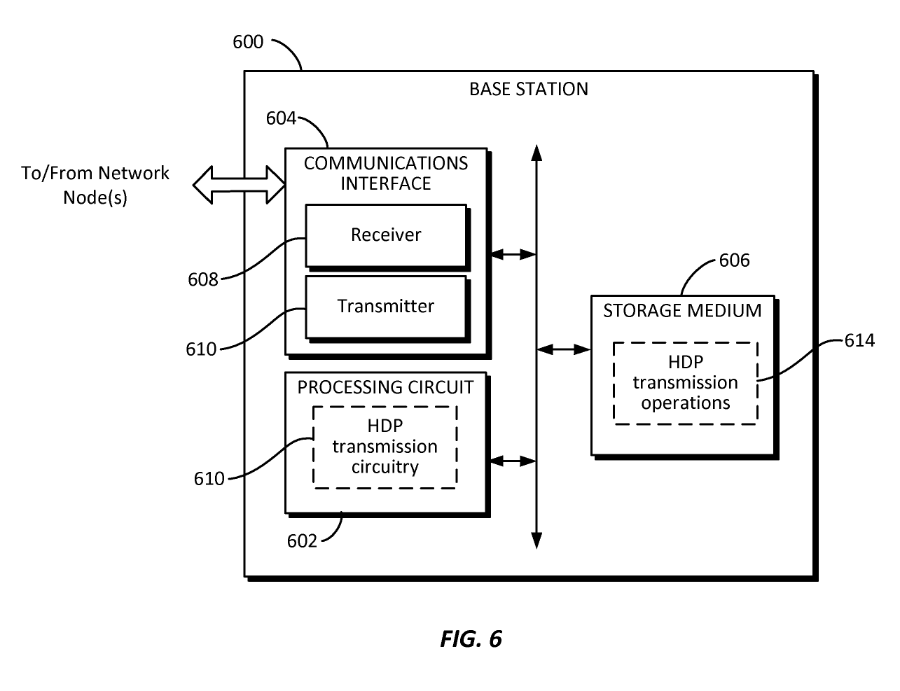

FIG. 4 is a conceptual diagram illustrating an access network 400 in accordance with one aspect of the disclosure, wherein each base station 402 has three sectors designated as α, β, and γ. That is, each base station 402 has three transmit antennas that act as separate cells. Of course, this is merely one example, and in accordance with various aspects of the disclosure a base station may include any suitable number of sectors from one or more. Moreover, the particular configuration of the access network illustrated in FIG. 6 is merely exemplary and nonlimiting in nature.

In the illustrated access network 400, in some aspects of the disclosure, the cells may be partitioned into a plurality of groups, arbitrarily designated by three colors: red, green, and blue. In the illustration, “red” cells are identified with the diagonal lines; “green” cells are unfilled with texture; and “blue” cells are identified with dots.

In this way, each sector can be identified by its pair (A, B) where A is the sector designator α, β, or γ, and B is the sector color, R, G, or B. Grid 450 shows how each sector in the access network 400 is identified by its respective sector designator and sector color pair. In this example, there are nine possible sector designator/sector color pairs, corresponding to the pairs (α, R); (α, G); (α, B); (β, R); (β, G); (β, B); (γ, R); (γ, G); and (γ, B).

In a further aspect of the disclosure, each particular pair is assigned a particular HDP PCG. Here, the reuse factor is 9, since every 9th sector utilizes the same HDP PCG. Thus, for every nine HDP PCGs, each sector transmits the HDP signal in one PCG, i.e., the designated HDP PCG for that pair (A, B). To keep the duty cycle low and thereby reduce the impact to data and signaling transmissions, e.g., 1%, a cycle of 900 PCGs may be used.

As described in further detail below, assignment of a particular pair to a particular sector can be either planned or random in a particular implementation. Moreover, the assignment of the pair to a particular sector can be fixed or altered over time within the scope of the disclosure.

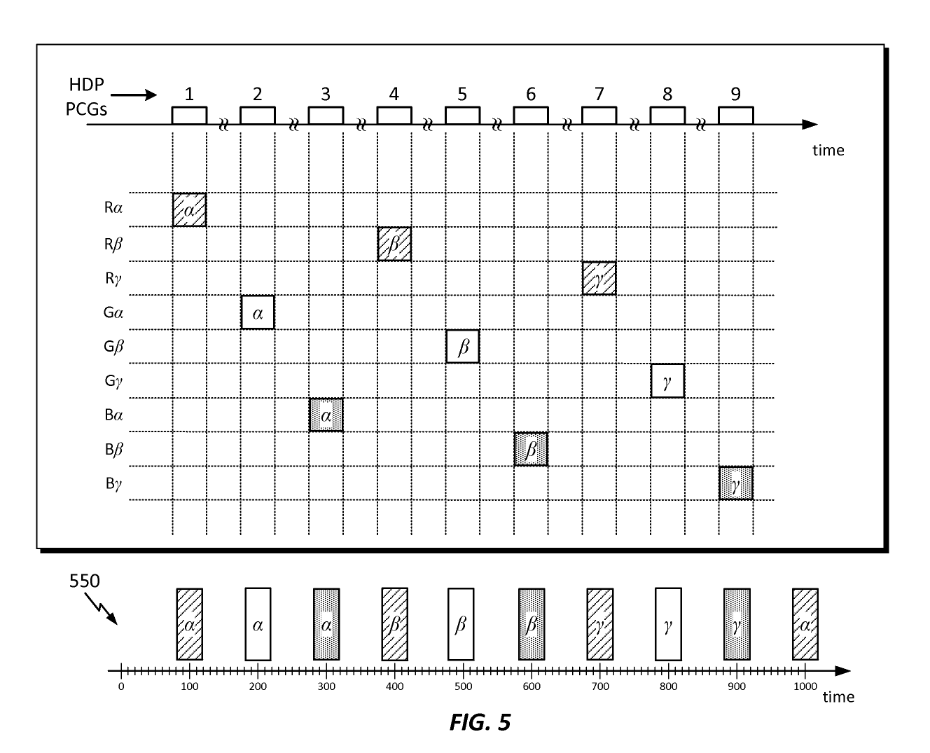

FIG. 5 is a conceptual diagram further illustrating the configuration and transmission of HDP PCGs in an exemplary access network according to some aspects of the disclosure. In the illustrated example, only the HDP PCGs are illustrated, with other PCGs, which may be utilized for other purposes such as the transmission of data and/or control signaling, omitted as designated with the double tilde (≈) mark.

As in FIG. 4, the illustration of FIG. 5 shows nine HDP PCGs, corresponding to the grid 450 described above. In some examples, the HDP PCGs may utilize a duty cycle of 1%, such that in between each of the illustrated HDP PCGs, 99 PCGs are omitted from the illustration. Thus, 900 PCGs pass during the time frame illustrated. As seen herein, during each HDP PCG, only one HDP is transmitted. Of course, in accordance with the re-use factor, a plurality of sectors may transmit the HDP during the same HDP PCG, but according to an aspect of the disclosure, the number of sectors transmitting HDPs during any particular HDP PCG may be relatively low, e.g., as in the illustrated example, one in nine sectors in the access network 400.

At the bottom portion of FIG. 5, a timeline 550 illustrates the HDP PCGs in another way to further improve the clarity. Here, again, only the HDP PCGs are illustrated (according to the grid 450), with all other PCGs omitted from the illustration. As above, only a subset of sectors, corresponding to the designated pair (A, B) in the illustration, transmit their pilot during each HDP PCG. In the timeline 550, 1000 PCGs are illustrated to show that the pattern of 9 HDP PCGs may repeat. Of course, as described below, this is merely one example, and the pattern may change after cycling through the 9 HDP PCGs one or more times.

In some examples, one or more cells in the access network may be configured not to transmit the HDP during the HDP PCGs. That is, such cells may be configured not to transmit, or to engage in blanking, during all HDP PCGs. This setting may be suitable for cells that do not help in positioning of the access terminal, such as a sector with multiple remote radio heads (e.g., as in a distributed antenna system).

FIG. 6 is a block diagram illustrating select components of a base station 600 adapted to employ such features according to at least one aspect of the disclosure. The base station 600 may include a processing circuit 602 coupled to a communications interface 604 and to a storage medium 606. In some examples, the base station 600 described herein may be utilized as the base station 202 or 402 described above in relation to FIGS. 2 and 4.

The processing circuit 602 is arranged to obtain, process and/or send data, control data access and storage, issue commands, and control other desired operations for the base station 600. The processing circuit 602 may include circuitry configured to implement desired programming provided by appropriate media in at least one example, and may be implemented and/or adapted in a manner similar to the processing circuit 114 described above.

The communications interface 604 is configured to facilitate wireless communications of the base station 600. For example, the communications interface 604 may include circuitry and/or programming adapted to facilitate the communication of information with respect to one or more access terminals 400. The communications interface 604 may be coupled to one or more antennas (not shown), and includes wireless transceiver circuitry, including at least one receiver circuit 608 (e.g., one or more receiver chains) and/or at least one transmitter circuit 610 (e.g., one or more transmitter chains). As described above, the base station 600 may utilize the communications interface 604 to communicate over a single sector, or may utilize the communications interface 604 to communicate over a plurality of sectors, such as the three-sector configuration described above and illustrated in FIG. 4.

The storage medium 606 may represent one or more devices for storing programming and/or data, such as processor executable code or instructions (e.g., software, firmware), electronic data, databases, or other digital information. The storage medium 606 may be configured and/or implemented in a manner similar to the computer-readable storage medium 106 described above.

Like the computer-readable storage medium 106, the storage medium 606 includes programming stored thereon. The programming stored by the storage medium 606, when executed by the processing circuit 602, causes the processing circuit 602 to perform one or more of the various functions and/or process steps described herein. The storage medium 606 may include HDP transmission operations (i.e., instructions) 614. The HDP transmission operations 614 may be implemented by the processing circuit 602 in, for example, the HDP transmission circuitry 612. Thus, according to one or more aspects of the present disclosure, the processing circuit 602 may be adapted to perform (in conjunction with the storage medium 606) any or all of the processes, functions, steps and/or routines for any or all of the network nodes described herein (e.g., base station controller 206 and/or PSTN or IP network 208 in FIG. 2). As used herein, the term “adapted” in relation to the processing circuit 602 may refer to the processing circuit 602 being one or more of configured, employed, implemented, and/or programmed to perform a particular process, function, step and/or routine according to various features described herein.

In various aspects of the disclosure, the allocation of HDP timing amongst the base stations 600 or their respective sectors in the access network may be a predetermined allocation or a random allocation. For example, in an access network with known base station 600 locations (or known cell locations in a distributed antenna system example utilizing remote radio heads), a predetermined allocation of the HDPs among the access network can provide closer to an optimum solution, wherein the number of HDPs that an access terminal might receive at any location within the access network can be increased. For example, the allocation of the HDPs may be designed such that the HDP transmission from each cell is spread out, increasing the number of HDPs from different cells that the access terminal might receive.

On the other hand, the allocation of the HDPs amongst the cells may be determined according to a random algorithm. Here, a random allocation can reduce the effort required to design the allocation of the system, and further, may lead to decreased maintenance of the system. The random allocation algorithm may be beneficial to a system where the base station or cell locations may frequently change over time, such that re-allocation according to a fixed algorithm and optimizing the layout to improve or maximize the number of HDPs an access terminal might receive, is unnecessary.

In an aspect of the disclosure, when utilizing the random HDP PCG assignment scheme, the transmission order of the HDP PCGs may remain fixed, e.g., according to the 900 PCG cycle described above. In another example, for every 900 PCGs, each base station 600 in the access network may randomly determine its color from the set {red, blue, green} and further, may randomly generate a label for each of its 3 sectors {α, β, γ}. Here, cell color and sector labeling may be determined independently across different cells and different 900 PCG groups. In this way, different randomized patterns for HDP transmission can be generated improving the likelihood of a high number of pilots received by an access terminal over time.

In some aspects of the disclosure, the base station 600 may advertise the HDP configuration to be utilized by access terminals in the access network 400 by transmitting an overhead message configured to inform the access terminals of the HDP configuration. In some examples, the HDP configuration message may include such configuration information as the HDP duty cycle N, the re-use factor K, and the pilot-to-HDP slot mapping. Furthermore, in some examples, the HDP configuration message may include the Walsh code to utilize for HDP transmissions, the pseudorandom number (PN) sequence or its offset to cover the HDP transmissions, or any other suitable configuration information corresponding to the transmission of the HDP.

In some examples, the HDP configuration message may be periodically broadcasted by the various cells in the access network utilizing any suitable broadcast channel such as the paging channel (PCH). However, the utilization of this additional overhead message may create an undesired increase in loading on 1× paging channel. Thus, in some examples, the HDP configuration message may be conveyed to the access terminal out-of-band, e.g., by utilizing IP communication to send the HDP configuration message from a network server to the access terminal.

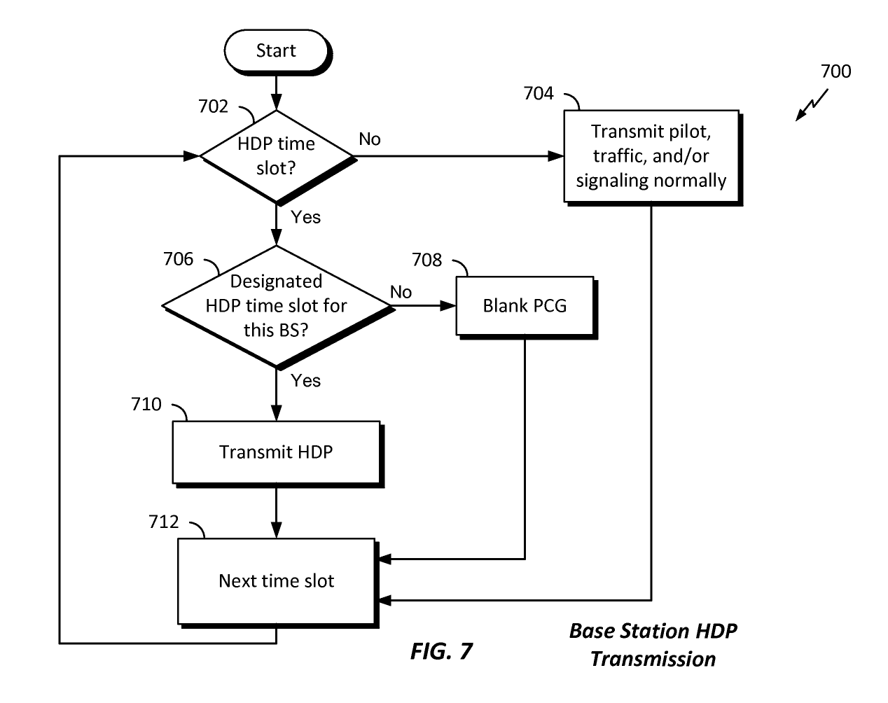

Once the access terminals in the access network are configured to listen for the HDP transmissions according to aspects of the disclosure, the base station 600 may begin transmitting the HDPs in accordance with the HDP configuration. FIG. 7 is a flow chart illustrating an exemplary process 700, operable at a base station such as the base station 600, for transmitting the HDP in accordance with an aspect of the disclosure. The illustrated process 700 assumes that configuration across the access network 400 has been set up according to either a predetermined scheme or a random scheme as described above, and that the HDP configuration information is known by access terminals within the access network 400.

In the description that follows, the process is described in relation to a “cell.” Here, as described above, this term is intended to be construed broadly to include the service area of a base station when the base station 600 communicates with a single sector, or in other examples, one of a plurality of service areas covered by a base station when the base station 600 communicates with a plurality of sectors.

The illustrated process 700 as shown loops each time slot or PCG. At step 702, the process determines whether the current PCG is an HDP PCG. When utilizing the scheme described above and illustrated in FIG. 5, with a duty cycle of 1%, one out of every 100 PCGs would be an HDP PCG. Of course, any suitable duty cycle may be utilized within the scope of the present disclosure. If the current PCG is not an HDP PCG, then the process may proceed to step 704, wherein the cell may transmit its pilot (e.g., the F-PICH), user traffic, and/or signaling normally, e.g., according to conventional standards. That is, during PCGs that are not HDP PCGs, aspects of the present disclosure generally do not interfere with normal operation of the access network. After a suitable duration, the process proceeds to step 712, wherein the next PCG may begin, and the process loops back to step 702.

If, on the other hand, the process determines at step 702 that the current PCG is an HDP PCG, then the process may proceed to step 706, wherein the cell may determine whether the current HDP PCG is the designated HDP PCG in which the cell is to transmit the HDP. That is, in accordance with a suitable re-use pattern, in some aspects of the disclosure only a subset of the cells in the access network transmit the HDP during any particular HDP PCG. When utilizing the re-use pattern described above in relation to FIG. 4, each cell transmits the HDP during one out of every 9 HDP PCGs. Here, when utilizing the 1% duty cycle in this example, the cell transmits the HDP once every 900 PCGs.

In some aspects of the disclosure, the determination as to whether the current HDP PCG is the designated HDP PCG in which the cell is to transmit the HDP may be made by comparing the designation of the cell according to the pair (A, B) as described above, with the HDP configuration utilized by the access network 400. If the process determines that the HDP PCG is not the designated HDP PCG in which the cell is to transmit the HDP, then the process may proceed to step 708 wherein the cell may blank any transmissions for the duration of the PCG. That is, in order to make other cells' transmissions of pilots more highly detectable during this PCG, in an aspect of the disclosure, cells that are not transmitting the HDP during any HDP PCG may cut off any transmission of legacy pilots, overhead, and traffic during that HDP PCG. In this way, the near-far effect can be reduced, in that the most proximate base station need not necessarily drown out pilot transmissions from other more distant cells, as the proximate base station may cut off transmissions at this time.

At the end of the blank PCG the process may proceed to step 712 and move to the next PCG, after which the process may loop back to step 702 for the next time slot.

On the other hand, if at step 706 the process determines that the current HDP PCG is the designated HDP PCG in which the cell is to transmit the HDP, then the process may proceed to step 710 wherein the cell may transmit the HDP. In some aspects of the disclosure, the HDP may be a pilot signal transmitted over the cell at full base station power, to improve the detectability of the pilot to potentially more distant access terminals. Further, in some examples, the HDP transmission may be substantially the same as a legacy pilot transmission, i.e., including a sequence of all 0s utilizing the cell's PN and a Walsh code of 0. In other examples, the HDP transmission may be similar to the legacy pilot transmission, but may utilize a dedicated Walsh code for HDP transmissions, other than Walsh code 0. Of course, those of ordinary skill in the art will comprehend that any suitable pilot transmission may be utilized as the HDP in accordance with design choices and implementation specifics for a particular network.

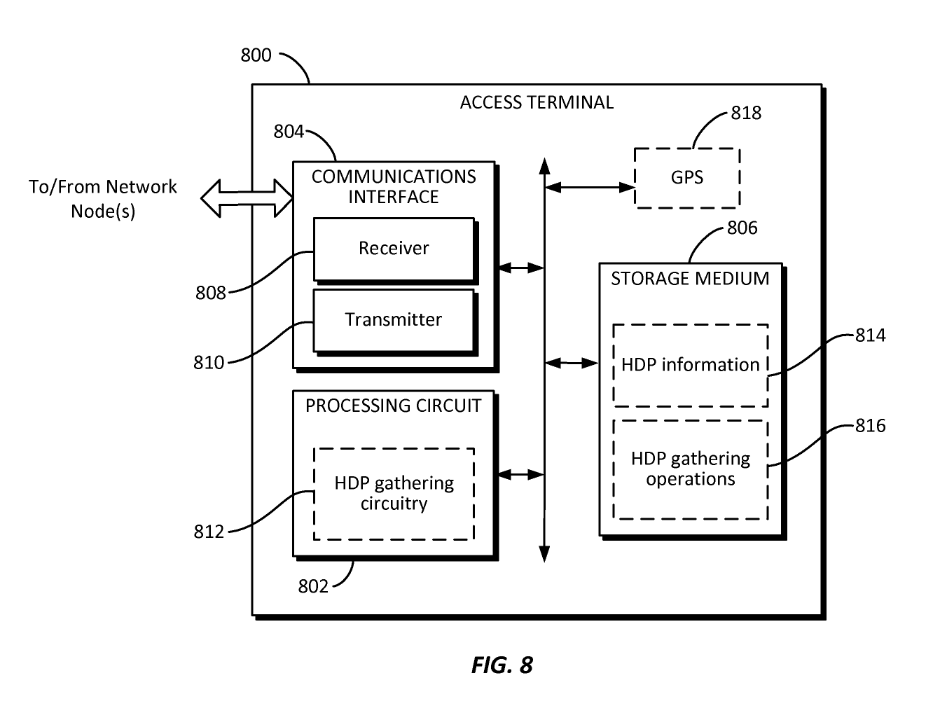

FIG. 8 is a block diagram illustrating select components of an access terminal 800 adapted to employ such features according to at least one example. The access terminal 800 may include a processing circuit 802 coupled to a communications interface 804, to a storage medium 806, and to optional GPS circuitry 808. In some examples, the access terminal 800 described herein may be utilized as the access terminal 204 described above in relation to FIG. 2.

The processing circuit 802 is arranged to obtain, process and/or send data, control data access and storage, issue commands, and control other desired operations for the access terminal 800. The processing circuit 802 may include circuitry configured to implement desired programming provided by appropriate media in at least one example, and may be implemented and/or adapted in a manner similar to the processing circuit 114 described above.

The communications interface 804 is configured to facilitate wireless communications of the access terminal 800. For example, the communications interface 804 may include circuitry and/or programming adapted to facilitate the communication of information bi-directionally with respect to one or more network nodes such as the base station 600. The communications interface 804 may be coupled to one or more antennas (not shown), and includes wireless transceiver circuitry, including at least one receiver circuit 808 (e.g., one or more receiver chains) and/or at least one transmitter circuit 810 (e.g., one or more transmitter chains). By way of example and not limitation, the at least one transmitter circuit 810 may include circuitry, devices and/or programming adapted to provide various signal conditioning functions including amplification, filtering, and modulating transmission frames onto a carrier for uplink transmission over a wireless medium through an antenna.

The storage medium 806 may represent one or more devices for storing programming and/or data, such as processor executable code or instructions (e.g., software, firmware), electronic data, databases, or other digital information. The storage medium 806 may be configured and/or implemented in a manner similar to the computer-readable storage medium 106 described above.

Like the computer-readable storage medium 106, the storage medium 806 includes programming stored thereon. The programming stored by the storage medium 806, when executed by the processing circuit 802, causes the processing circuit 802 to perform one or more of the various functions and/or process steps described herein. The storage medium 806 may be utilized to store HDP information 814 corresponding to one or more received HDPs. Furthermore, the storage medium 806 may include HDP gathering operations (i.e., instructions) 814. The HDP gathering operations 814 can be implemented by the processing circuit 802 in, for example, the HDP gathering circuitry 812. Thus, according to one or more aspects of the present disclosure, the processing circuit 802 may be adapted to perform any or all of the processes, functions, steps and/or routines for any or all of the access terminals (e.g., access terminal 204 or 800) described herein. As used herein, the term “adapted” in relation to the processing circuit 802 may refer to the processing circuit 802 being one or more of configured, employed, implemented, or programmed to perform a particular process, function, step and/or routine according to various features described herein.

In various aspects of the disclosure, the access terminal 800 may receive an HDP configuration message from one or more cells in the access network. With the information in the HDP configuration message, the access terminal 800 may be enabled to retrieve the HDPs transmitted from the different cells in the access network for utilization in positioning the access terminal 800. As described above, the HDP configuration message may include such configuration information as the HDP duty cycle N, the re-use factor K, and the pilot-to-HDP slot mapping. Furthermore, in some examples, the HDP configuration message may include the Walsh code to utilize for HDP transmissions, the pseudorandom number (PN) sequence or its offset to cover the HDP transmissions, or any other suitable configuration information corresponding to the transmission of the HDP. In some examples, the HDP configuration message may be received on any suitable broadcast channel such as the paging channel (PCH), or in an out-of-band message such as an IP message utilizing higher layers.

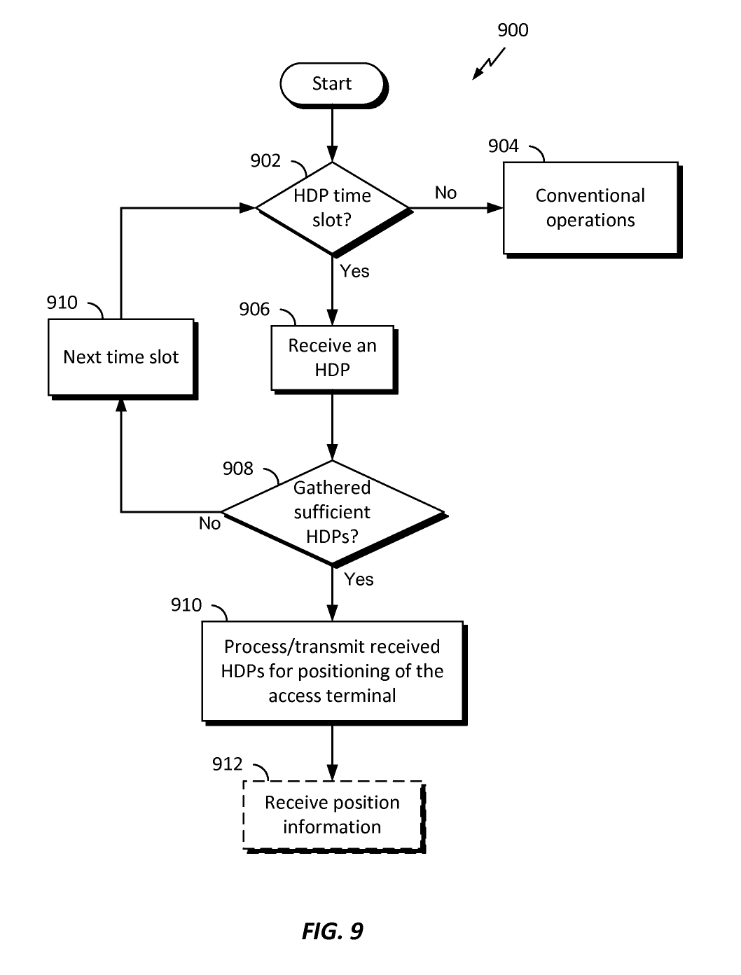

Once the access terminal 800 is configured to listen for the HDP transmissions according to aspects of the disclosure, the access terminal 800 may begin receiving the HDPs in accordance with the HDP configuration. FIG. 9 is a flow chart illustrating an exemplary process 900, operable at an access terminal such as the access terminal 800, for receiving the HDP in accordance with an aspect of the disclosure. The illustrated process 900 assumes that the access terminal 800 has received the HDP configuration information message and is informed of the timing of the PCGs that contain the HDP transmissions.

The illustrated process 900 as shown begins after the HDP configuration message is received and the access terminal 800 is configured in accordance with the received information. At step 902, the access terminal 800 may determine whether the current PCG is an HDP PCG. Here, in some aspects of the disclosure, relatively few of the PCGs might be HDP PCGs, in accordance with a suitable duty cycle communicated to the access terminal 800 with the HDP configuration message described above. For example, continuing with the example illustrated in FIG. 5, 1% of the PCGs may be HDP PCGs, with the specific timing and selection of HDP PCGs among all PCGs being known by the access terminal 800. If the access terminal 800 determines that the current PCG is not an HDP PCG, then the process may proceed to step 904, wherein the access terminal 800 may undergo conventional operations such as communicating user traffic, control signaling, and/or processing of conventional pilot transmissions from one or more base stations in the relevant access network.

On the other hand, if at step 902 the access terminal 800 determines that the current PCG is an HDP PCG, then the process may proceed to step 906, wherein the access terminal may perform a suitable search and detection procedure to detect an HDP transmission from a nearby cell. Here, in some aspects of the disclosure, only a subset of nearby base stations may be transmitting the HDP during the HDP PCG, in accordance with the re-use factor being utilized in the access network. For example, continuing with the example described above in relation to FIG. 4, one out of every 9 base stations in the access network may transmit the HDP during any particular HDP PCG, the selection of which of the base stations to transmit during that PCG being made in accordance with a suitable predetermined or random pattern, as described above. Once the HDP is retrieved by the access terminal, information corresponding to the base station transmitting the received HDP may be stored at the access terminal, e.g., at the storage medium 806.

At step 908 the access terminal 800 may determine whether a suitable number of HDPs have been gathered. If not, the process may proceed to step 910 and move to the next PCG, after which the process may loop back to step 902. That is, in some examples, the illustrated loop may repeat for a suitable number of iterations, such as corresponding to the re-use factor. Of course, any suitable number of HDPs may be gathered and stored in the access terminal 800 in a particular implementation within the scope of the disclosure. If sufficient HDP information has been gathered by the access terminal 800, then the process may proceed to step 912, wherein the access terminal 800 may process and/or report HDP information received and stored as described above. That is, in some aspects of the disclosure, the access terminal 800 may include suitable databases and processing capabilities to determine its own position in accordance with the received HDP information for the plurality of cells. In other aspects of the disclosure, the access terminal 800 may report information corresponding to the received HDP information. Here, the reporting mechanism utilized by the access terminal 800 may remain unchanged relative to conventional 1× AFLT. That is, the utilization of the HDP PCG algorithm described in the present disclosure may provide for a larger number of detected pilots, but the reporting of those pilots for the positioning of the access terminal 800 need not necessarily be altered relative to conventional positioning technology. Of course, any suitable reporting mechanism for reporting the HDP information may be utilized within the scope of the present disclosure.

At step 912, the access terminal may optionally receive position information from the network responsive to the transmission of the HDP information in step 910.

One or more of the components, steps, features and/or functions illustrated in FIGS. 1-7 may be rearranged and/or combined into a single component, step, feature or function or embodied in several components, steps, or functions. Additional elements, components, steps, and/or functions may also be added without departing from the invention. The apparatus, devices and/or components illustrated in FIGS. 1, 3, 4, 6, and/or 7 may be configured to implement and/or perform one or more of the methods, features, or steps described in FIG. 5. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The terms “machine-readable medium”, “computer-readable medium”, and/or “processor-readable medium” may include, but are not limited to portable or fixed storage devices, optical storage devices, and various other non-transitory mediums capable of storing, containing or carrying instruction(s) and/or data. Thus, the various methods described herein may be partially or fully implemented by instructions and/or data that may be stored in a “machine-readable medium”, “computer-readable medium”, and/or “processor-readable medium” and executed by one or more processors, machines and/or devices.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

We claim:

1. A method of positioning an access terminal in a wireless communication network, comprising:
transmitting a pilot if a current time slot is a designated highly detectable pilot (HDP) time slot; and
blanking pilot, traffic, and signaling transmissions if the current time slot is an HDP time slot that is not a designated HDP time slot.

2. The method of claim 1, wherein the wireless communication network is a cdma2000 1× network.

3. The method of claim 1, wherein the transmitting of the pilot comprises transmitting at a full base station power level.

4. The method of claim 1,
wherein a plurality of HDP time slots are a portion of all time slots in accordance with a duty cycle, and
wherein the designated HDP time slot is one of a plurality of designated HDP time slots, wherein the plurality of designated HDP time slots are a portion of the plurality of HDP time slots in accordance with a re-use factor.

5. The method of claim 4, wherein the duty cycle is 0.5%, 1%, or 2% of all the time slots.

6. The method of claim 4, wherein the re-use factor is one out of every nine HDP time slots.

7. The method of claim 4, further comprising:
receiving from a network server a predetermined assignment of the designated HDP time slot for transmission of the pilot; and
transmitting a configuration message for indicating the predetermined assignment to one or more access terminals.

8. The method of claim 7, wherein the configuration message comprises one or more of the HDP duty cycle, the HDP re-use factor, or a pilot-to-HDP time slot mapping.

9. The method of claim 8, wherein the configuration message further comprises one or more of a Walsh code, a pseudorandom number sequence, or a pseudorandom number offset to utilize for the pilot transmissions.

10. The method of claim 7, wherein the configuration message is transmitted on a paging channel (PCH).

11. The method of claim 7, wherein the configuration message is transmitted to an access terminal utilizing an IP packet.

12. The method of claim 4, further comprising:
randomly selecting the designated HDP time slot for transmission of the pilot from among the plurality of HDP time slots; and
transmitting a configuration message for indicating the selected designated HDP time slot to one or more access terminals.

13. The method of claim 12, wherein the configuration message comprises one or more of the HDP duty cycle, the HDP re-use factor, or a pilot-to-HDP time slot mapping.

14. The method of claim 13, wherein the configuration message further comprises one or more of a Walsh code, a pseudorandom number sequence, or a pseudorandom number offset to utilize for the pilot transmissions.

15. The method of claim 12, wherein the configuration message is transmitted on a paging channel (PCH).

16. The method of claim 12, wherein the configuration message is transmitted to an access terminal utilizing an IP message.

17. A method of positioning an access terminal in a wireless communication network, comprising:
determining that a current time slot is a highly detectable pilot (HDP) time slot;
receiving an HDP transmission during the current time slot;
storing information corresponding to the received HDP in memory;
transmitting a reporting message comprising the information corresponding to the received HDP; and
receiving position information responsive to the transmitting of the reporting message.

18. The method of claim 17, further comprising:
receiving a configuration message for indicating an HDP configuration of the wireless communication network,
wherein the configuration message comprises an HDP-to-time slot mapping adapted to indicate which time slots are the HDP time slots.

19. The method of claim 18, wherein the HDP configuration message is received on a paging channel (PCH).

20. The method of claim 18, wherein the HDP configuration message is received as an IP message.

21. A base station configured for positioning an access terminal in a wireless communication network, comprising:
means for transmitting a pilot if a current time slot is a designated highly detectable pilot (HDP) time slot; and
means for blanking pilot, traffic, and signaling transmissions if the current time slot is an HDP time slot that is not a designated HDP time slot.

22. The base station of claim 21, wherein the wireless communication network is a cdma2000 1× network.

23. The base station of claim 21, wherein the means for transmitting the pilot is configured for transmitting at a full base station power level.

24. The base station of claim 21,
wherein a plurality of HDP time slots are a portion of all time slots in accordance with a duty cycle, and
wherein the designated HDP time slot is one of a plurality of designated HDP time slots, wherein the plurality of designated HDP time slots are a portion of the plurality of HDP time slots in accordance with a re-use factor.

25. The base station of claim 24, wherein the duty cycle is 0.5%, 1%, or 2% of all the time slots.

26. The base station of claim 24, wherein the re-use factor is one out of every nine HDP time slots.

27. The base station of claim 24, further comprising:
means for receiving from a network server a predetermined assignment of the designated HDP time slot for transmission of the pilot; and
means for transmitting a configuration message for indicating the predetermined assignment to one or more access terminals.

28. The base station of claim 27, wherein the configuration message comprises one or more of the HDP duty cycle, the HDP re-use factor, or a pilot-to-HDP time slot mapping.

29. The base station of claim 28, wherein the configuration message further comprises one or more of a Walsh code, a pseudorandom number sequence, or a pseudorandom number offset to utilize for the pilot transmissions.

30. The base station of claim 27, wherein the configuration message is transmitted on a paging channel (PCH).

31. The base station of claim 27, wherein the configuration message is transmitted to an access terminal utilizing an IP packet.

32. The base station of claim 24, further comprising:
means for randomly selecting the designated HDP time slot for transmission of the pilot from among the plurality of HDP time slots; and
means for transmitting a configuration message for indicating the selected designated HDP time slot to one or more access terminals.

33. The base station of claim 32, wherein the configuration message comprises one or more of the HDP duty cycle, the HDP re-use factor, or a pilot-to-HDP time slot mapping.

34. The base station of claim 33, wherein the configuration message further comprises one or more of a Walsh code, a pseudorandom number sequence, or a pseudorandom number offset to utilize for the pilot transmissions.

35. The base station of claim 32, wherein the configuration message is transmitted on a paging channel (PCH).

36. The base station of claim 32, wherein the configuration message is transmitted to an access terminal utilizing an IP message.

37. An access terminal configured for positioning in a wireless communication network, comprising:
means for determining that a current time slot is a highly detectable pilot (HDP) time slot;
means for receiving an HDP transmission during the current time slot;
means for storing information corresponding to the received HDP in memory;
means for transmitting a reporting message comprising the information corresponding to the received HDP; and
means for receiving position information responsive to the transmitting of the reporting message.

38. The access terminal of claim 37, further comprising:
means for receiving a configuration message for indicating an HDP configuration of the wireless communication network,
wherein the configuration message comprises an HDP-to-time slot mapping adapted to indicate which time slots are the HDP time slots.

39. The access terminal of claim 38, wherein the HDP configuration message is received on a paging channel (PCH).

40. The access terminal of claim 38, wherein the HDP configuration message is received as an IP message.

41. A base station configured for positioning an access terminal in a wireless communication network, comprising:
a processing circuit;
a communications interface coupled to the processing circuit; and
a memory coupled to the processing circuit,
wherein the processing circuit is configured to:
transmit a pilot if a current time slot is a designated highly detectable pilot (HDP) time slot; and
blank pilot, traffic, and signaling transmissions if the current time slot is an HDP time slot that is not a designated HDP time slot.

42. The base station of claim 41, wherein the wireless communication network is a cdma2000 1× network.

43. The base station of claim 41, wherein the transmitting of the pilot comprises transmitting at a full base station power level.

44. The base station of claim 41,
wherein a plurality of HDP time slots are a portion of all time slots in accordance with a duty cycle, and
wherein the designated HDP time slot is one of a plurality of designated HDP time slots, wherein the plurality of designated HDP time slots are a portion of the plurality of HDP time slots in accordance with a re-use factor.

45. The base station of claim 44, wherein the duty cycle is 0.5%, 1%, or 2% of all the time slots.

46. The base station of claim 44, wherein the re-use factor is one out of every nine HDP time slots.

47. The base station of claim 44, wherein the processing circuit is further configured to:
receive from a network server a predetermined assignment of the designated HDP time slot for transmission of the pilot; and
transmit a configuration message for indicating the predetermined assignment to one or more access terminals.

48. The base station of claim 47, wherein the configuration message comprises one or more of the HDP duty cycle, the HDP re-use factor, or a pilot-to-HDP time slot mapping.

49. The base station of claim 48, wherein the configuration message further comprises one or more of a Walsh code, a pseudorandom number sequence, or a pseudorandom number offset to utilize for the pilot transmissions.

50. The base station of claim 47, wherein the configuration message is transmitted on a paging channel (PCH).

51. The base station of claim 47, wherein the configuration message is transmitted to an access terminal utilizing an IP packet.

52. The base station of claim 44, wherein the processing circuit is further configured to:
randomly select the designated HDP time slot for transmission of the pilot from among the plurality of HDP time slots; and
transmit a configuration message for indicating the selected designated HDP time slot to one or more access terminals.

53. The base station of claim 52, wherein the configuration message comprises one or more of the HDP duty cycle, the HDP re-use factor, or a pilot-to-HDP time slot mapping.

54. The base station of claim 53, wherein the configuration message further comprises one or more of a Walsh code, a pseudorandom number sequence, or a pseudorandom number offset to utilize for the pilot transmissions.

55. The base station of claim 52, wherein the configuration message is transmitted on a paging channel (PCH).

56. The base station of claim 52, wherein the configuration message is transmitted to an access terminal utilizing an IP message.

57. An access terminal configured for positioning in a wireless communication network, comprising:
a processing circuit;
a communications interface coupled to the processing circuit; and
a memory coupled to the processing circuit,
wherein the processing circuit is configured to:
determine that a current time slot is a highly detectable pilot (HDP) time slot;
receive an HDP transmission during the current time slot;
store information corresponding to the received HDP in memory;
transmit a reporting message comprising the information corresponding to the received HDP; and
receive position information responsive to the transmitting of the reporting message.

58. The access terminal of claim 57, wherein the processing circuit is further configured to:
receive a configuration message for indicating an HDP configuration of the wireless communication network,
wherein the configuration message comprises an HDP-to-time slot mapping adapted to indicate which time slots are the HDP time slots.

59. The access terminal of claim 58, wherein the HDP configuration message is received on a paging channel (PCH).

60. The access terminal of claim 58, wherein the HDP configuration message is received as an IP message.

61. A computer program product operable at a base station, comprising:
a computer-readable storage medium comprising:
instructions for causing a computer to:
transmit a pilot if a current time slot is a designated highly detectable pilot (HDP) time slot; and
blank pilot, traffic, and signaling transmissions if the current time slot is an HDP time slot that is not a designated HDP time slot.

62. The computer program product of claim 61, wherein the wireless communication network is a cdma2000 1× network.

63. The computer program product of claim 61, wherein the transmitting of the pilot comprises transmitting at a full base station power level.

64. The computer program product of claim 61,
wherein a plurality of HDP time slots are a portion of all time slots in accordance with a duty cycle, and
wherein the designated HDP time slot is one of a plurality of designated HDP time slots, wherein the plurality of designated HDP time slots are a portion of the plurality of HDP time slots in accordance with a re-use factor.

65. The computer program product of claim 64, wherein the duty cycle is 0.5%, 1%, or 2% of all the time slots.

66. The computer program product of claim 64, wherein the re-use factor is one out of every nine HDP time slots.

67. The computer program product of claim 64, wherein the computer-readable storage medium further comprises instructions for causing a computer to:
receive from a network server a predetermined assignment of the designated HDP time slot for transmission of the pilot; and
transmit a configuration message for indicating the predetermined assignment to one or more access terminals.

68. The computer program product of claim 67, wherein the configuration message comprises one or more of the HDP duty cycle, the HDP re-use factor, or a pilot-to-HDP time slot mapping.

69. The computer program product of claim 68, wherein the configuration message further comprises one or more of a Walsh code, a pseudorandom number sequence, or a pseudorandom number offset to utilize for the pilot transmissions.

70. The computer program product of claim 67, wherein the configuration message is transmitted on a paging channel (PCH).

71. The computer program product of claim 67, wherein the configuration message is transmitted to an access terminal utilizing an IP packet.

72. The computer program product of claim 64, wherein the computer-readable storage medium further comprises instructions for causing a computer to:
randomly select the designated HDP time slot for transmission of the pilot from among the plurality of HDP time slots; and
transmit a configuration message for indicating the selected designated HDP time slot to one or more access terminals.

73. The computer program product of claim 72, wherein the configuration message comprises one or more of the HDP duty cycle, the HDP re-use factor, or a pilot-to-HDP time slot mapping.

74. The computer program product of claim 73, wherein the configuration message further comprises one or more of a Walsh code, a pseudorandom number sequence, or a pseudorandom number offset to utilize for the pilot transmissions.

75. The computer program product of claim 72, wherein the configuration message is transmitted on a paging channel (PCH).

76. The computer program product of claim 72, wherein the configuration message is transmitted to an access terminal utilizing an IP message.

77. A computer program product operable at an access terminal, comprising:
a computer-readable storage medium comprising:
instructions for causing a computer to:
determine that a current time slot is a highly detectable pilot (HDP) time slot;
receive an HDP transmission during the current time slot;
store information corresponding to the received HDP in memory;
transmit a reporting message comprising the information corresponding to the received HDP; and
receive position information responsive to the transmitting of the reporting message.

78. The access terminal of claim 77, wherein the computer-readable storage medium further comprises instructions for causing a computer to:
receive a configuration message for indicating an HDP configuration of the wireless communication network,
wherein the configuration message comprises an HDP-to-time slot mapping adapted to indicate which time slots are the HDP time slots.

79. The access terminal of claim 78, wherein the HDP configuration message is received on a paging channel (PCH).

80. The access terminal of claim 78, wherein the HDP configuration message is received as an IP message.
